(19) United States
(12) Patent Application Publication
(10) Pub. No.: US 2006/0181205 A1
(43) Pub. Date: Aug. 17, 2006

(54) Liquid crystal display using organic electroluminescence backlight

(75) Inventors: Woo Kap Pi, Seoul (KR); Seung Jun Yi, Seoul (KR); Kyung Hee Choi, Seoul (KR); Byung Hyun Byun, Seoul (KR)

Correspondence Address: BACON & THOMAS, PLLC, 625 SLATERS LANE, FOURTH FLOOR, ALEXANDRIA, VA, 22314, US

(73) Assignee: DAEWOO ELECTRONICS Corporation, Seoul (KR)

(21) Appl. No.: 11/355,892

(22) Filed: Feb. 17, 2006

(30) Foreign Application Priority Data
Feb. 17, 2005 (KR) 10-2005-0013044

(51) Int. Cl. H01J 1/62

(52) U.S. Cl. 313/506

(57) ABSTRACT

A liquid crystal display includes an organic EL device for a backlight. The liquid crystal display is fabricated by performing the steps of preparing a separate glass substrate; attaching a polarizing film on the separate glass substrate; forming a backlight on the polarizing film using the separate glass substrate as a support plate, wherein the backlight includes an organic EL device having a cathode layer, an organic thin-film layer and an anode layer sequentially stacked on the polarizing film; separating the polarizing film having the backlight thereon from the separate glass substrate; and attaching the polarizing film on a lower surface of a glass substrate, the glass substrate having a TFT array and pixel electrode.

### FIELD OF THE INVENTION

The present invention relates to a liquid crystal display, and more particularly, to a liquid crystal display using a backlight comprised of an organic electroluminescence (EL) device wherein the EL device is integrally formed on a polarizing film.

### BACKGROUND OF THE INVENTION

As is known in the art, differently from a cathode ray tub (CRT) being a representative emissive display, a liquid crystal display (LCD) is not a spontaneous-emissive display device that requires a light source to maintain uniform brightness in an entire screen.

LCDs may be cartegorized into reflective, transmissive and transflective type LCDs, depending upon the form of illumination. The light source employed in a transmissive or a transflective LCD is referred to as a backlight. The backlight may be divided into a direct type or an edge type, pursuant to the location of the light source.

Referring to FIG. 1, there is shown a typical LCD device. In general, the LCD device is divided into three parts, e.g., a display module 10, a video processing unit 20, and a power supplying unit 17. The display module 10 includes a TFT-LCD panel 16, drivers 14 and 15, and a backlight 19; and the video processing unit 20 includes a VRAM board 11, a timing controller 12 and a line memory 13.

The video random access memory (VRAM) board with a CPU (Central Processing Unit) incorporated therein 11 stores video data to be displayed and produces a video signal RGB and a synchronization signal SYNC. The timing controller 12 receives from the VRAM board 11 the video signal RGB and the synchronization signal SYNC to produce various timing signals necessary to drive the display module 10. The video signal RGB to be displayed is temporally stored in a line memory 13, and then is transmitted to a data driver 15. The timing signals from the timing controller 12 are fed to a scan driver 14. The data driver 15 is also referred to as a source driver, and the scan driver 14 is also referred to as a gate driver.

The backlight 19, upon receiving the output of the power supply 17 through an inverter 18 emits light. Various light sources including a small electric bulb, an inorganic thick-film EL display, a light emitting diode (LED), a cold cathode fluorescent lamp (CCFL) and an external electrode fluorescent lamp (EEFL) have been employed for the backlight 19. Among them, the CCFL is most commonly used as the backlight for a super twisted nematic (STN)-LCD or thin film transistor (TFT)-LCD since it is capable of producing high-luminance light required for full color representation.

However, the CCFL not only consumes a large amount of power but also is thick, thereby hindering thinness and miniaturization of the LCD.

The above problems will be discussed in more detail with reference to FIGS. 2 and 3.

FIG. 2 is a sectional view illustrating a portion of the LCD shown in FIG. 1, and FIG. 3 shows a detailed structure of a pixel in the LCD shown in FIG. 2.

As shown in FIG. 2, the LCD panel 16 comprises a lower glass substrate 22B having pixel electrodes 25B and a TFT array 27 arranged in a matrix, an upper glass substrate 22T having a common electrode 25T and color filters 23, and liquid crystals 26 inserted between the lower glass substrate 22B and upper glass substrate 22T. A backlight 19 is located under the LCD panel 16. A lower polarizing film 21B is attached on the lower surface of the lower glass substrate 22B; and the pixel electrodes 25B and the TFT array 27 are formed on the upper surface of the lower glass substrate 22B. An upper polarizing film 21T is attached on an upper surface of the upper glass substrate 22T; and the color filters 23, black matrixes 24 and the common electrode 25T are formed in the lower surface of the upper glass substrate 22T.

The pixel includes a red R, green G and blue B color filters 23, the common electrode 25T, and data and gate lines as shown in FIG. 3.

In the LCD as described above, white light from the backlight 19 is controlled to regulate the amount of the light while passing through the liquid crystals 26. The controlled white light then passes through the R, G and B color filters 23 to thereby reproduce full-color images. However, the color filters 23 used in the LCD have a light transmittance of about 30% to 40%. Hence, a higher-luminance backlight is needed in the LCD.

The CCFL has been employed for a backlight unit in the LCD since it is capable of producing high-luminance light. However, the CCFL for the backlight not only consumes a large amount of power, but also is thicker than the other ones, which results in thickening the LCD device. Because the thickness in the backlight is one of significant factors for reducing the overall size of the LCD, the thick CCFL acts a limitation to hinder the miniaturization of the LCD.

### SUMMARY OF THE INVENTION

Therefore, an object of the present invention is to provide a liquid crystal display (LCD) having an organic electroluminescence (EL) backlight wherein an EL device is integrally formed on a polarizing film attached on a lower substrate having a thin film transistor (TFT) array.

In accordance with an aspect of the present invention, there is provided a liquid crystal display, which includes: a lower substrate having pixel electrodes and a thin film transistor (TFT) array; an upper substrate having a common electrode and color filters; liquid crystal materials inserted between the lower substrate and upper substrate; an upper polarizing film formed on a surface of the upper substrate; a lower polarizing film formed on a surface of the lower substrate; and a backlight for emitting light to illuminate the upper and the lower substrates, wherein the backlight includes an organic EL device integrally formed on the lower polarizing film as a single body.

In accordance with another aspect of the present invention, there is provided a method of fabricating a liquid crystal display, which includes: preparing a separate glass substrate; attaching a polarizing film on the separate glass substrate; forming a backlight on the polarizing film using the separate glass substrate as a support plate, wherein the backlight includes an organic EL device having a cathode layer, an organic thin-film layer and an anode layer sequentially stacked on the polarizing film; separating the polarizing film having the backlight thereon from the separate glass substrate; and attaching the polarizing film on a lower surface of a glass substrate, the glass substrate having a TFT array and pixel electrodes.

In accordance with further another aspect of the present invention, there is provided a method of fabricating a liquid crystal display, which includes: preparing a plastic substrate; attaching a polarizing film onto the plastic substrate; forming a backlight on the polarizing film, wherein the backlight includes an organic EL device having a cathode layer, an organic thin-film layer and an anode layer formed in sequence; and attaching the plastic substrate in reverse onto a lower surface of a glass substrate, the glass substrate having a TFT array and pixel electrodes.

### BRIEF DESCRIPTION OF THE DRAWINGS

The above and other objects and features of the present invention will become apparent from the following description of preferred embodiments given in conjunction with the accompanying drawings, in which:

FIG. 1 shows an overall configuration of a typical LCD;

FIG. 2 is a sectional view illustrating a portion of the LCD shown in FIG. 1;

FIG. 3 illustrates a detailed structure of a pixel in the LCD shown in FIG. 2;

FIG. 4 is a sectional view of the structure of an LCD having an organic EL backlight in according with the present invention;

FIG. 5 is a sectional view of the organic EL for a backlight in the LCD in FIG. 4;

FIGS. 6A to 6C depicts a process of fabricating an LCD having an organic EL backlight in accordance with the present invention; and

FIGS. 7A to 7C shows a process of fabricating an LCD having an organic EL backlight in accordance with another embodiment of the present invention.

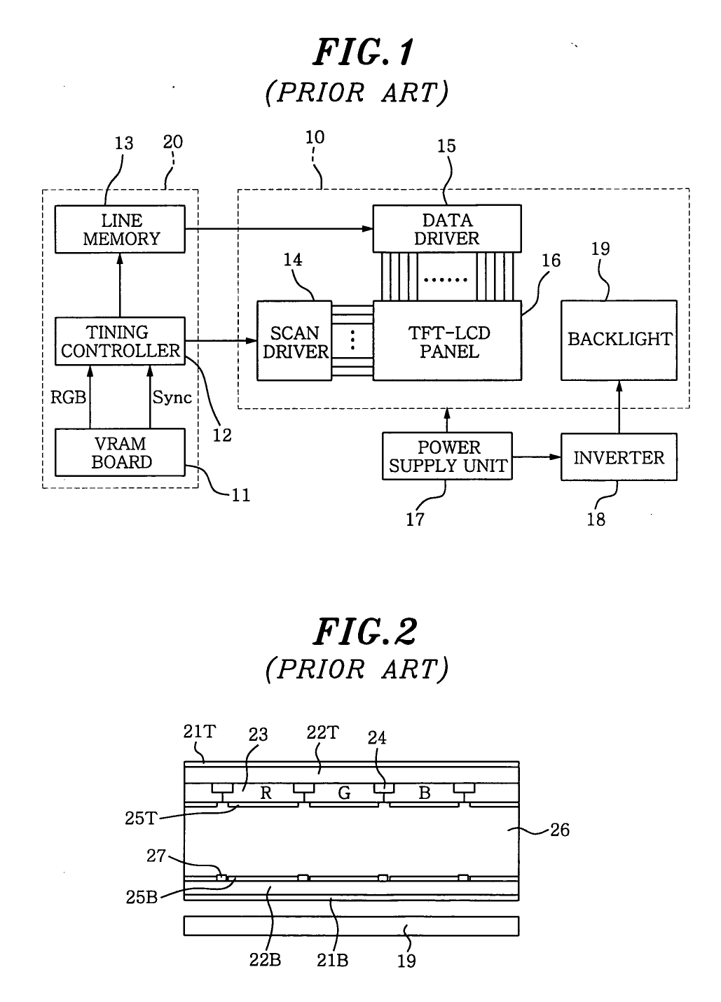

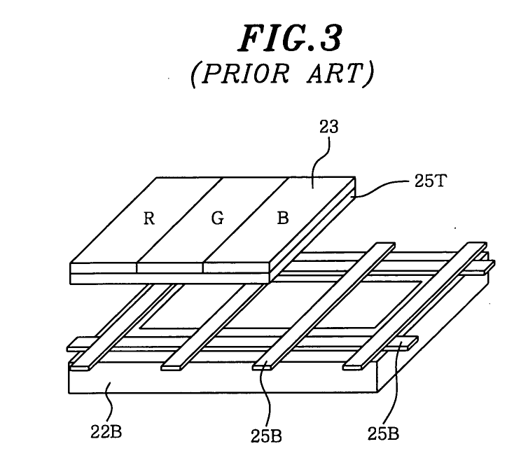

### DETAILED DESCRIPTION OF THE PREFERRED EMBODIMENTS

Hereinafter, preferred embodiments of the present invention will be described in detail with reference to the accompanying drawings. In the drawings, the thickness of various layers and regions may be enlarged for clear illustration, and the same or similar elements are denoted by the same reference numerals even though they are depicted in different drawings.

Referring to FIG. 4, there is shown a sectional view of a liquid crystal display (LCD) having an organic electroluminescence (EL) backlight according to a preferred embodiment of the present invention.

As shown in FIG. 4, the LCD comprises a lower glass substrate 22B having pixel electrodes 25B and a TFT array 27 arranged in a matrix, an upper glass substrate 22T having a common electrode 25T and color filters 23, and liquid crystals 26 inserted between the lower glass substrate 22B and the upper glass substrate 22T. Further, an upper polarizing film 21T is attached on an upper surface of the upper glass substrate 22T; and the R, G and B color filters 23, black matrixes 24 and the common electrode 25T are arranged in a lower surface of the upper glass substrate 22T.

The pixel electrodes 25B and the TFT array 27 are formed on an upper surface of the lower glass substrate 22B; and a lower polarizing film 21B is attached on the lower surface of the lower glass substrate 22B.

The LCD further comprises an organic EL backlight 30. The organic EL backlight 30 is attached to one side, e.g., a lower surface, of the lower polarizing film 21B whose other side is attached on the lower surface of the lower glass substrate 22B. The organic EL backlight 30 includes an anode layer 31, an organic thin-film layer 32 and a cathode layer 33 that are stacked in sequence to thereby form an organic EL device. In particular, the anode layer 31 is directly contacted with the lower surface of the lower polarizing film 21B, so that the organic EL backlight 30 is integrally formed with the lower polarizing film 21B as a single body. That is, the LCD has a configuration to incorporate the organic EL backlight 30 therein as a single body. Such a configuration does not require a separate power supply for a conventional backlight unit. The organic EL backlight 30 is a low power device, thereby minimizing power consumption of the LCD. Moreover, the organic EL backlight 30 is thinner than a conventional CCFL backlight in thickness, thereby enabling miniaturization of the LCD.

On the other hand, because the organic EL backlight 30 is susceptible to moisture and oxygen as similar as a conventional organic EL device, it is preferable to cover the cathode layer 33 with a passivation layer 40 so that the organic EL backlight 30 is protected against moisture and oxygen permeation.

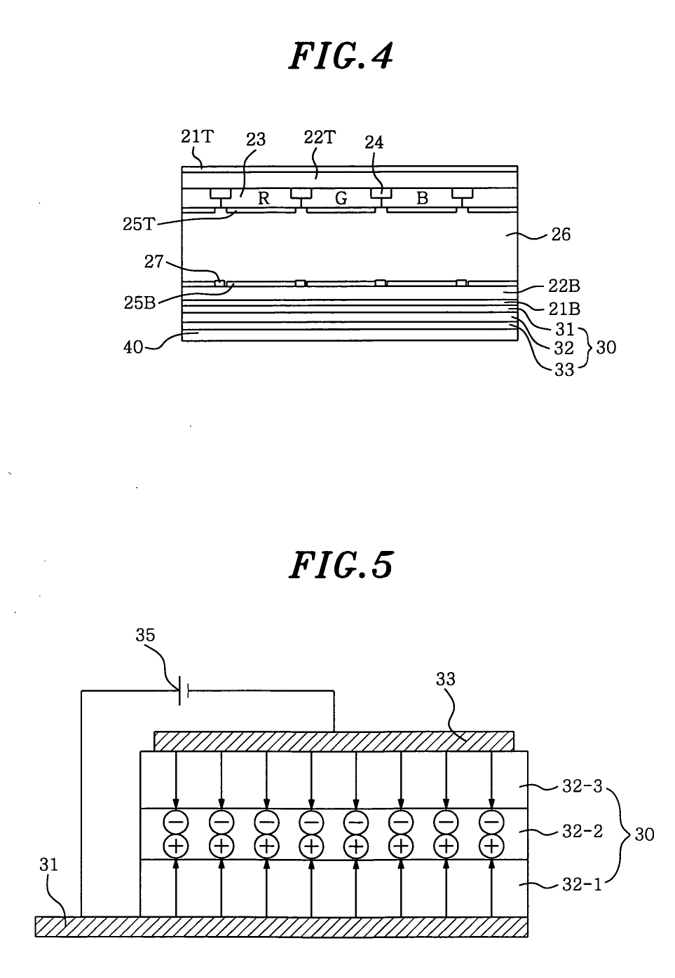

FIG. 5 is a sectional view of an organic EL backlight in the LCD in FIG. 4. The organic EL backlight 30 includes the anode layer 31 made of a transparent conductive material having a high work function such as indium tin oxide (ITO), polyaniline and silver (Ag), the organic thin-film layer 32 formed on the anode layer 31, and the cathode layer 33 formed on the organic thin-film layer 32 and made of a low work function metal such as aluminum (Al). A separate power source 35 is provided to supply an electrical power to the organic EL device. The anode layer 31 is connected to a positive terminal of the power source 35, while the cathode layer 33 is connected to a negative terminal of the power source 35. The organic thin-film layer 32 has a hole injection/transport layer 32-1, an emission layer 32-2, and an electron injection/transport layer 32-3. The hole injection/transport layer 32-1 serves to transport holes injected from the anode layer 31 to the emission layer 32-2. The electron injection/transport layer 32-3 serves to transport electrons injected from the cathode layer 33 to the emission layer 32-2. The emission layer 32-2 serves to emit light through the combination of the transported electrons and holes.

The hole injection/transport layer 32-1 has a hole injection layer and a hole transfer layer, and the electron injection/transport layer 32-3 has an electron injection layer and an electron transfer layer. Such layers as the hole injection layer, the hole transport layer, the electron injection layer and the electron transport layer may be made of materials employed to fabricate the organic EL devices.

Because the organic EL device is used for a backlight in the LCD, it is required for the emission layer 32-2 to emit white light. To emit white light, the emission layer 32-2 is formed as a single layer of a white-light-emitting material or a multi-layered structure having red-, green- and blue-phosphor layers.

In case that the emission layer 32-2 has the multi-layered structure, red light, green light, blue light are emitted from the red-, green- and blue-phosphor layers, respectively, and combined with one another so that the organic EL device can exhibit white light.

Alternatively, the emission layer 32-2 may be formed as a multi-layered structure having blue- and red-phosphor layers or as a single layer structure made of a blue-light-emitting host material doped with a red-light-emitting dopant. Such an organic EL device can exhibit white light.

Light-emitting materials known in the art may be used for the white-light-emitting material and red, green and blue phosphors.

The organic EL device has a spontaneous emissive property producing high-luminance light. Moreover, the organic EL device has advantages of a simple structure, a lightweight and thinness. In addition, it is ease to manufacture the organic EL device. Accordingly, the organic EL backlight comprised of the organic EL device according to the present invention is capable of providing a high-luminance display and attributing to fabricate the compact LCD.

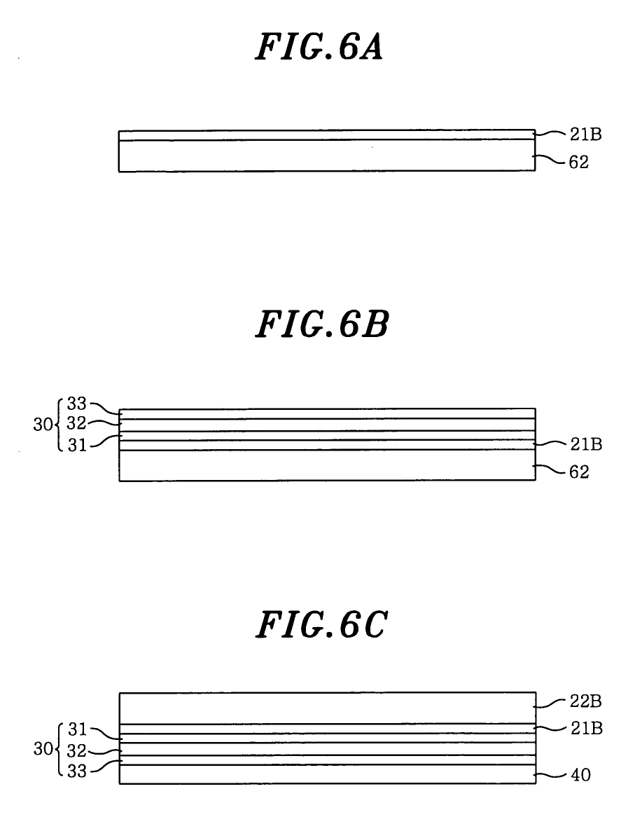

Referring to FIGS. 6A to 6C, there is shown a process of fabricating an LCD having an organic EL backlight in accordance with the present invention.

As known in the art, a typical polarizing film has very thin in thickness, e.g., below about 200 μm. Hence, it is difficult to make any device such as an organic EL device directly fabricate on the polarizing film. In order to overcome the above problem, the present invention utilizes a separate substrate as will be explained hereinafter.

Firstly, as shown in FIG. 6A, a separate third glass substrate 62 is prepared and a lower polarizing film 21B is then attached on the third glass substrate 62.

An anode 31, an organic thin-film layer 32 and a cathode layer 33 are then sequentially formed on the lower polarizing film 21B using the third glass substrate as a support plate, to thereby form an organic EL backlight 30, as shown in FIG. 6B. In the course of the formation of the organic EL backlight 30, the anode layer 31, e.g., made of an ITO (Indium-Tin Oxide), may be patterned by using a metal mask at the time of the formation thereof or a photolithographic process after the formation of the anode layer 31 in order to establish an anode electrode.

Thereafter, as shown in FIG. 6C, the lower polarizing film 21B having the backlight 30 thereon is separated from the third glass substrate 62. The separated lower polarizing film 21B from the third glass substrate 62 is then attached on the lower surface of the lower glass substrate 22B, to thereby fabricate the LCD wherein the organic EL backlight 30 is integrally formed on the lower polarizing film 21B as shown in FIG. 4. In this connection, there is shown in FIG. 4 that the anode layer 31 of the organic EL backlight 30 is in direct contact with the lower polarizing film 21B.

In this regard, after attaching the lower polarizing film 21B having the organic EL backlight to the lower surface of the lower glass substrate 22B, it is preferable to form a passivation layer 40 through usual passivation layer formation such as an encapsulation process to protect the organic EL backlight 30 against moisture and oxygen permeation.

Alternatively, a lower polarizing film 21B may be attached on a lower surface of a lower glass substrate 22B having the organic EL device formed thereon, and then an organic EL device may be formed on the lower polarizing film 21B, thereby fabricating the LCD.

At this time, before attaching the third glass substrate 62 having the backlight 30 and the lower polarizing film 21B to the lower surface of the lower glass substrate 22B, a passivation layer 40 may be formed to cover the organic EL device so that the organic EL backlight 30 is protected against moisture and oxygen permeation.

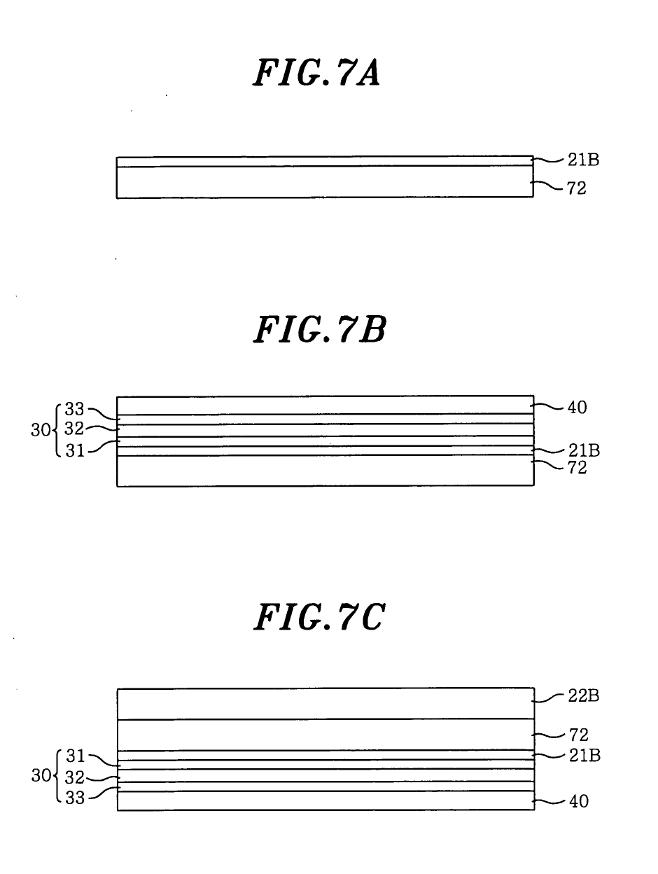

Referring to FIGS. 7A to 7C, there is shown a process of fabricating an LCD having an organic EL backlight in accordance with a second preferred embodiment of the present invention.

Firstly, as shown in FIG. 7A, a transparent plastic substrate 72 is prepared and a lower polarizing film 21B is attached on an upper surface of the transparent plastic substrate 72. The plastic substrate 72 may be made of material selected from a group including Polyimide (PI), Polyethersulphone (PES), Polyacrylate(PAR), Polycarbonate (PC), Polyethylenenaphthalate (PEN), Polyethyleneterephthalate (PET) and the like.

Thereafter, as shown in FIG. 7B, an anode 31, an organic thin-film layer 32 and a cathode layer 33 are then sequentially formed on the polarizing film 21B, to thereby form an organic EL backlight 30. If necessary, a passivation layer 40 may be additionally formed on the cathode layer 33. In this connection, before the formation of the anode layer 31, it is preferable to have the polarizing film 21B subjected to a surface treatment so as to enhance the property of adhesion of the anode layer 31 to the polarizing film 21B. The adhesive property may further be enhanced through forming an inorganic buffer layer such as a silicon oxide (SiO₂) film or silicon nitride (Si₃N₄) film on the plastic substrate. In addition, the anode layer 31 may be patterned by using a metal mask at the time of the formation thereof, to thereby form an anode electrode.

The plastic substrate 72 having the polarizing film 21B with the organic EL backlight 30 thereon is upset and attached on a lower surface of a lower glass substrate 22B having a TFT array 27, as shown in FIG. 7C, to thereby fabricate the LCD wherein the organic EL backlight 30 is integrally formed with the lower polarizing film 21B as a single body.

With this method, differently from the structure shown in FIG. 4, the plastic substrate is disposed between the lower glass substrate 22B and the lower polarizing film 21B, and the plastic substrate is in direct contact with the lower glass substrate 22B.

In the manufacturing method according to the second embodiment, it has been shown and described that the passivation layer 40 is formed after the formation of the organic EL device. Alternatively, the passivation layer 40 may be formed after completely attaching the plastic substrate on the lower surface of the lower glass substrate 22B. As apparent from the above description, the present invention aims to provide an LCD having an organic EL device for a backlight wherein the organic EL device is integrally formed on a polarizing film. Consequently, the thickness of the LCD can be minimized, and the LCD can be most compact.

In addition, the backlight is made of the organic EL device, thereby enabling achievement of high luminance and low power consumption.

While the invention has been shown and described with respect to the preferred embodiments, it will be understood by those skilled in the art that various changes and modifications may be made without departing from the spirit and scope of the invention as defined in the following claims.

What is claimed is:

1. A liquid crystal display comprising:
a lower substrate having pixel electrodes and a thin film transistor (TFT) array;
an upper substrate having a common electrode and color filters;
liquid crystal materials inserted between the lower substrate and upper substrate;
an upper polarizing film formed on a surface of the upper substrate;
a lower polarizing film formed on a surface of the lower substrate; and
a backlight for emitting light to illuminate the upper and the lower substrates,
wherein the backlight includes an organic EL device integrally formed on the lower polarizing film as a single body.

2. The liquid crystal display of claim 1, wherein the organic EL device includes an anode layer, an organic thin-film layer and a cathode layer that are stacked in sequence and wherein the anode layer of the organic EL device is in direct contact with the lower polarizing film.

3. The liquid crystal display of claim 2, wherein the organic EL device further includes a passivation layer formed on the cathode layer so that the backlight is protected against moisture and oxygen permeation.

4. The liquid crystal display of claim 2, wherein the organic thin-film layer includes a hole transport layer, an emission layer, and an electron transport layer.

5. The liquid crystal display of claim 4, wherein the emission layer includes a multi-layered structure having a red-phosphor layer, a green-phosphor layer, and a blue-phosphor layer.

6. The liquid crystal display of claim 4, wherein the emission layer includes a multi-layered structure having a blue-phosphor layer and a red-phosphor layer.

7. The liquid crystal display of claim 4, wherein the emission layer includes a single layer structure made of a blue-light-emitting host material doped with a red-light-emitting dopant.

8. A method of fabricating a liquid crystal display comprising:
preparing a separate glass substrate;
attaching a polarizing film on the separate glass substrate;
forming a backlight on the polarizing film using the separate glass substrate as a support plate, wherein the backlight includes an organic EL device having a cathode layer, an organic thin-film layer and an anode layer sequentially stacked on the polarizing film;
separating the polarizing film having the backlight thereon from the separate glass substrate; and
attaching the polarizing film on a lower surface of a glass substrate, the glass substrate having a TFT array and pixel electrodes.

9. The method of claim 8, further comprising the step of forming a passivation layer on the cathode layer so that the backlight is protected against moisture and oxygen permeation.

10. The method of claim 8, wherein the step of forming the backlight includes patterning the anode layer using a metal mask at the time of the formation of the anode layer in order to form an anode electrode.

11. A method of fabricating a liquid crystal display comprising:
preparing a plastic substrate;
attaching a polarizing film onto the plastic substrate;
forming a backlight on the polarizing film, wherein the backlight includes an organic EL device having a cathode layer, an organic thin-film layer and an anode layer formed in sequence; and
attaching the plastic substrate in reverse onto a lower surface of a glass substrate, the glass substrate having a TFT array and pixel electrodes.

12. The method of claim 11, further comprising the step of forming a passivation layer on the cathode layer so that the backlight is protected against moisture and oxygen permeation.

13. The method of claim 11, further comprising the step of performing a surface treatment on the polarizing film, before the formation of the anode layer thereon, so as to enhance the property of adhesion of the anode layer to the polarizing film.

14. The method of claim 11, further comprising the step of forming an inorganic buffer layer on the polarizing film, so as to enhance the property of adhesion of the anode layer to the polarizing film.

15. The method of claim 14, wherein the inorganic buffer layer includes a silicon oxide (SiO₂) film or a silicon nitride (Si₃N₄) film.

16. The method of claim 11, wherein the step of forming the backlight includes patterning the anode layer using a metal mask at the time of the formation of the anode layer in order to form an anode electrode.
